(19) United States
(12) Patent Application Publication
(10) Pub. No.: US 2013/0264876 A1
(43) Pub. Date: Oct. 10, 2013

(54) INVERTER ASSEMBLY AND SOLAR POWER PLANT COMPRISING THE SAME

(71) Applicant: ABB OY, Helsinki (FI)

(72) Inventor: Mikko Paakkinen, Vantaa (FI)

(73) Assignee: ABB Oy, Helsinki (FI)

(21) Appl. No.: 13/859,302

(22) Filed: Apr. 9, 2013

(30) Foreign Application Priority Data
Apr. 10, 2012 (EP) 12163558.5

(51) Int. Cl. H02M 7/5387

(52) U.S. Cl. CPC H02M 7/53871
USPC 307/52; 363/74

(57) ABSTRACT

An inverter assembly having a DC circuit, inverter, and controller (CTRL) configured to control the inverter, the inverter being, for example, a multilevel inverter having a first half bridge (HB1) and a second half bridge (HB2). The controller (CTRL) can be adapted to provide a first operating state in which the controller (CTRL) operates the inverter as a full-bridge inverter. The controller (CTRL) is further adapted to provide at least one further operating state in which the controller (CTRL) operates the inverter as a half-bridge inverter, the controller (CTRL) being adapted to select an operating state based on predetermined conditions.

### RELATED APPLICATION(S)

This application claims priority under 35 U.S.C. §119 to European Patent Application No. 12163558.5 filed in Europe on Apr. 10, 2012, the entire contents of which is hereby incorporated by reference in its entirety.

### FIELD

The present disclosure relates to an inverter assembly.

### BACKGROUND INFORMATION

A full-bridge inverter is known in the art. A full-bridge NPC inverter is also known in the art. Known full-bridge inverters have relatively high switching losses.

### SUMMARY

An inverter assembly is disclosed, comprising: a DC circuit, wherein the DC circuit includes a positive busbar, a negative busbar and input capacitor means, the input capacitor means having a midpoint and connected between the positive busbar and the negative busbar; inverter means, the inverter means being adapted to convert a direct current supplied through the positive busbar and the negative busbar to an alternating current, and configured to feed the alternating current through output terminals of the inverter means to an electrical network having a network voltage, wherein the inverter means is a multilevel inverter means including a first half bridge and a second half bridge, each of the first and second half bridges having controllable switches; and control means configured to control the inverter means, the control means being adapted to provide a first operating state in which the control means operates the inverter means as a full-bridge inverter, and wherein the control means is adapted to provide at least one further operating state in which the control means operates the inverter means as a half-bridge inverter, wherein one of the half bridges is disconnected from the positive busbar and the negative busbar while a neutral reference point of said one of the half bridges is connected to the midpoint of the input capacitor means, the control means being adapted to select an operating state based on predetermined conditions.

A solar power plant is disclosed, comprising: power supply means, the power supply means comprising at least one photovoltaic cell unit and supply terminals, each of the at least one photovoltaic cell unit being adapted to convert solar energy into direct current and to feed the direct current out of the power supply means via the supply terminals; an inverter assembly, the inverter comprising: a DC circuit, wherein the DC circuit includes a positive busbar, a negative busbar and input capacitor means, the input capacitor means having a midpoint and connected between the positive busbar and the negative busbar; inverter means, the inverter means being adapted to convert a direct current supplied through the positive busbar and the negative busbar to an alternating current, and configured to feed the alternating current through output terminals of the inverter means to an electrical network having a network voltage, wherein the inverter means is a multilevel inverter means including a first half bridge and a second half bridge, each of the first and second half bridges having controllable switches; and control means configured to control the inverter means, the control means being adapted to provide a first operating state in which the control means operates the inverter means as a full-bridge inverter, and wherein the control means is adapted to provide at least one further operating state in which the control means operates the inverter means as a half-bridge inverter, wherein one of the half bridges is disconnected from the positive busbar and the negative busbar while a neutral reference point of said one of the half bridges is connected to the midpoint of the input capacitor means, the control means being adapted to select an operating state based on predetermined conditions; and wherein the supply terminals of the power supply means are connected to the positive busbar and the negative busbar.

### BRIEF DESCRIPTION OF THE DRAWINGS

In the following, the disclosure will be described in greater detail by reference to exemplary embodiments and the attached drawings, in which:

FIG. 1 shows an exemplary inverter assembly according to an embodiment of the disclosure;

FIG. 2 shows the exemplary inverter assembly of FIG. 1 in an operating state; and

FIG. 3 shows an exemplary inverter assembly according to an embodiment of the disclosure.

### DETAILED DESCRIPTION

The present disclosure relates to an exemplary inverter assembly, which includes a DC circuit, inverter means (e.g., controlled switches), and control means (e.g., specially programmed processor) for controlling the inverter means. The DC circuit includes a positive busbar, a negative busbar and input capacitor means, an input direct voltage present between the positive busbar and the negative busbar during use, the input capacitor means having a midpoint and connected between the positive busbar and the negative busbar. The inverter means can be adapted to convert a direct current supplied through the positive busbar and the negative busbar to an alternating current, and to feed the alternating current through output terminals of the inverter means to an electrical network having a network voltage. The inverter means can be a multilevel inverter means comprising a first half bridge and a second half bridge, both the first half bridge and the second half bridge comprising controllable switches. The control means can be adapted to provide a first operating state in which the control means operate the inverter means as a full-bridge inverter, wherein the control means are further adapted to provide at least one further operating state in which the control means operate the inverter means as a half-bridge inverter, wherein one of the half bridges is disconnected from the positive busbar and the negative busbar while a neutral reference point of the one half bridge is connected to the midpoint of the input capacitor means, the control means being adapted to select an operating state based on predetermined conditions.

In accordance with an exemplary embodiment, a solar power plant is disclosed, which includes the inverter assembly.

In accordance with an exemplary embodiment, a full bridge inverter is operated as a half-bridge inverter in predetermined circumstances. In accordance with an exemplary embodiment, the inverter assembly of the disclosure can provide reduction in switching and/or conducting state losses.

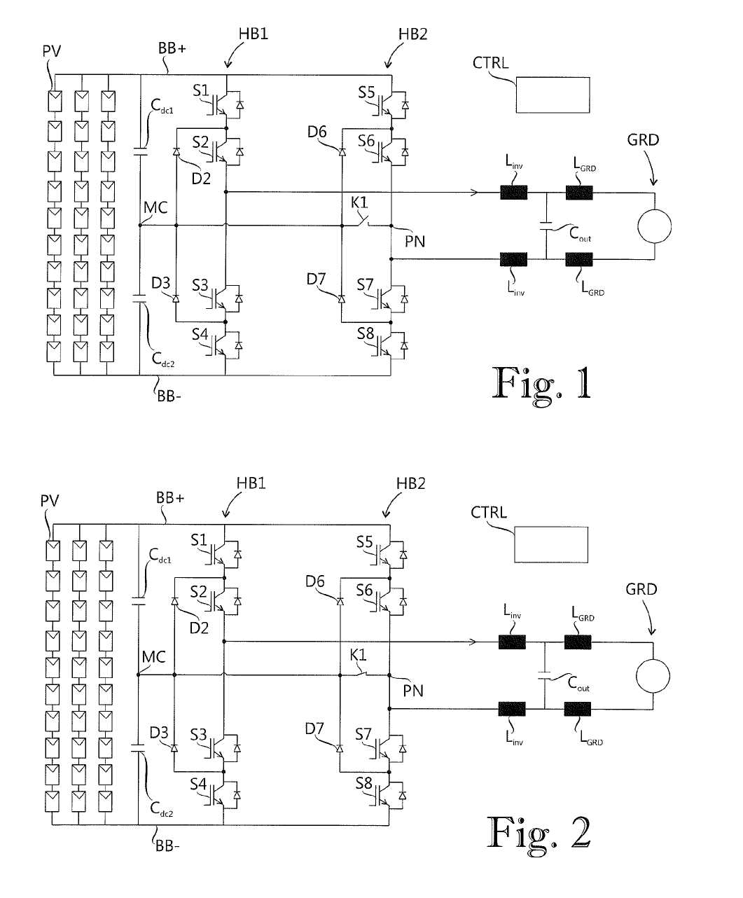

FIG. 1 shows an exemplary inverter assembly comprising a DC circuit, inverter means, and control means CTRL for controlling the inverter means.

The DC circuit can include a positive busbar BB+, a negative busbar BB−, and input capacitor means. During use, an input direct voltage U_{dc} can be present between the positive busbar BB+ and the negative busbar BB−. Herein, a busbar can be any electrically conductive element suitable for forming a part of a DC circuit. The input capacitor means can include a first energy storage capacitor C_{dc1} and a second energy storage capacitor C_{dc2} connected in series between the positive busbar BB+ and the negative busbar BB−. There is a midpoint MC between the first energy storage capacitor C_{dc1} and the second energy storage capacitor C_{dc2}.

The inverter means can be adapted to convert a direct current supplied into the inverter means through the positive busbar BB+ and the negative busbar BB− to an alternating current, and to feed the alternating current through output terminals of the inverter means to an electrical network GRD having a network voltage which is an alternating voltage. The inverter means can be a multilevel inverter means comprising a first half bridge HB1 and a second half bridge HB2.

The first half bridge HB1 can include controllable switches S1, S2, S3 and S4 connected in series between the positive busbar BB+ and the negative busbar BB-. The first half bridge HB1 can include a first diode leg including diodes D3 and D2 connected in series. A first end of the first diode leg can be connected to a point between controllable switches S3 and S4. A second end of the first diode leg can be connected to a point between controllable switches S1 and S2. Anode of diode D2 and cathode of diode D3 can be connected to the midpoint MC of the input capacitor means.

The second half bridge HB2 can include controllable switches S5, S6, S7 and S8 connected in series between the positive busbar BB+ and the negative busbar BB−. The second half bridge HB2 can include a second diode leg including diodes D7 and D6 connected in series. A first end of the second diode leg can be connected to a point between controllable switches S7 and S8. A second end of the second diode leg can be connected to a point between controllable switches S5 and S6. Anode of diode D6 and cathode of diode D7 can be connected to the midpoint MC of the input capacitor means.

In accordance with an exemplary embodiment, the inverter assembly can include a switch element K1 between a neutral reference point PN and the midpoint MC of the input capacitor means. The neutral reference point PN can be a point between controllable switches S6 and S7. In its on-position the switch element K1 electrically connects the neutral reference point PN and the midpoint MC. In its off-position the switch element K1 electrically separates the neutral reference point PN and the midpoint MC.

The neutral reference point PN can be connected to a neutral terminal of the electrical network GRD through a neutral leg comprising an inverter side inductor Lᵢₙᵥ and a grid side inductor L_{GRD} connected in series. The inverter assembly can include a phase leg whose first end can be connected to the first half bridge HB1 between the controllable switches S2 and S3, and whose second end can be connected to a phase terminal of the electrical network GRD. The phase leg can include an inverter side inductor Lᵢₙᵥ and a grid side inductor L_{GRD} connected in series.

An output capacitor Cₒᵤₜ can be connected between the phase leg and the neutral leg. One terminal of the output capacitor Cₒᵤₜ can be connected to the phase leg between the inverter side inductor Lᵢₙᵥ and the grid side inductor L_{GRD}, while the other terminal of the output capacitor Cₒᵤₜ can be connected to the neutral leg between the inverter side inductor Lᵢₙᵥ and the grid side inductor L_{GRD}.

The control means CTRL can be adapted to provide a first operating state in which the control means CTRL operate the inverter means as a full-bridge inverter. A switching table 1 shows positions of the controllable switches S1 to S8 during the first operating state, and corresponding values of an output voltage Uₒᵤₜ. The switching table 1 also shows that the switch element K1 can be in its off-position during the first operating state. FIG. 1 shows the inverter assembly in the first operating state.

SWITCHING TABLE 1
a first operating state.

| Switch | | | | |
|---|---|---|---|---|
| S1 | 1 | 0 | 0 | 0 |
| S2 | 1 | 0 | 1 | 0 |
| S3 | 0 | 1 | 0 | 1 |
| S4 | 0 | 1 | 0 | 0 |
| S5 | 0 | 1 | 0 | 0 |
| S6 | 0 | 1 | 0 | 1 |
| S7 | 1 | 0 | 1 | 0 |
| S8 | 1 | 0 | 0 | 0 |
| K1 | 0 | 0 | 0 | 0 |
| Uₒᵤₜ | +U_{dc} | −U_{dc} | 0a | 0b |

The control means CTRL can be adapted to provide a second operating state and a third operating state. In both the second operating state and the third operating state the control means CTRL operate the inverter means as a half-bridge inverter such that the second half bridge HB2 can be disconnected from the positive busbar BB+ and the negative busbar BB− while the neutral reference point PN can be connected to the midpoint MC of the input capacitor means. The control means CTRL can be adapted to select an operating state based on predetermined conditions.

A switching table 2 shows positions of the controllable switches S1 to S8 during the second operating state, and corresponding values of an output voltage Uₒᵤₜ. Controllable switches S5 and S8 can be open thereby disconnecting the second half bridge HB2 from the positive busbar BB+ and the negative busbar BB−. According to the switching table 2 the neutral reference point PN can be connected to the midpoint MC of the input capacitor means through a subset of the controllable switches of the second half bridge HB2, namely through controllable switches S6 and S7. The switch element K1 can be in its off-position throughout the second operating state. FIG. 1 also depicts the inverter assembly in the second operating state.

SWITCHING TABLE 2
a second operating state.

| Switch | | | | |
|---|---|---|---|---|
| S1 | 1 | 0 | 0 | 0 |
| S2 | 1 | 0 | 1 | 0 |
| S3 | 0 | 1 | 0 | 1 |
| S4 | 0 | 1 | 0 | 0 |
| S5 | 0 | 0 | 0 | 0 |
| S6 | 0 | 1 | 0 | 1 |
| S7 | 1 | 0 | 1 | 0 |
| S8 | 0 | 0 | 0 | 0 |
| K1 | 0 | 0 | 0 | 0 |
| Uₒᵤₜ | +U_{dc}/2 | −U_{dc}/2 | 0a | 0b |

Compared to the first operating state, the second operating state can induce less losses since switching losses and conducting state losses of controllable switches S5 and S8 are eliminated.

A switching table 3 shows positions of the controllable switches S1 to S8 during the third operating state, and corresponding values of an output voltage Uₒᵤₜ. Controllable switches S5 and S8 can be open thereby disconnecting the second half bridge HB2 from the positive busbar BB+ and the negative busbar BB−. The neutral reference point PN can be connected to the midpoint MC of the input capacitor means through the switch element K1 which is in its on-position throughout the third operating state. FIG. 2 shows the inverter assembly in the third operating state.

SWITCHING TABLE 3
a third operating state.

| Switch | | | | |
|---|---|---|---|---|
| S1 | 1 | 0 | 0 | 0 |
| S2 | 1 | 0 | 1 | 0 |
| S3 | 0 | 1 | 0 | 1 |
| S4 | 0 | 1 | 0 | 0 |
| S5 | 0 | 0 | 0 | 0 |
| S6 | 0 | 0 | 1 | 1 |
| S7 | 0 | 0 | 1 | 1 |
| S8 | 0 | 0 | 0 | 0 |
| K1 | 1 | 1 | 1 | 1 |
| Uₒᵤₜ | +U_{dc}/2 | −U_{dc}/2 | 0a | 0b |

Compared to the first operating state the third operating state induces less losses since switching losses and conducting state losses of controllable switches S5 and S8 are eliminated, and conducting state losses of controllable switches S6 and S7 and diodes D6 and D7 can be eliminated.

In an exemplary embodiment switches S6 and S7 can be kept open throughout the third operating state. This procedure can eliminate switching losses of the switches S6 and S7 during the third operating state.

When transferring from the third operating state to the second operating state, the control means CTRL first start to control the controllable switches S6 and S7 according to the network voltage before opening the switch element K1.

In the exemplary embodiments shown in FIGS. 1 and 2 the switch element K1 can be a relay. Conducting state losses of a relay can be lower than conducting state losses of a known controllable switch of an inverter. In an exemplary embodiment, the switch element may be other type of switch. For example, the switch element may be a semiconductor switch having low conducting state losses.

The control means CTRL can be adapted to select an operating state based on the input direct voltage U_{dc} and the network voltage. For example, when the input direct voltage U_{dc} is less than twice an absolute value of instantaneous value of the network voltage the control means CTRL selects the first operating state. The condition for the first operating state can be expressed by equation:

U_{dc}<2|u_{ac}|.

In an exemplary embodiment, when the input direct voltage U_{dc} is greater than twice an absolute value of instantaneous value of the network voltage the control means CTRL selects the second operating state. The condition for the second operating state can be expressed by equation:

U_{dc}>2|u_{ac}|.

When the input direct voltage U_{dc} is greater than twice a peak value of the network voltage the control means CTRL selects the third operating state. The condition for the third operating state can be expressed by equation:

U_{dc}>2û_{ac}.

For example, the above definitions show that when the input direct voltage U_{dc} is greater than twice a peak value of the network voltage the second operating state and the third operating state are alternatives to each other. In an exemplary embodiment, the second operating state can be used when the input direct voltage U_{dc} is greater than twice a peak value of the network voltage. In such an exemplary embodiment, for example, the switch element is not needed.

Depending on an exemplary embodiment, the control means may be adapted to cease modulation when the input direct voltage is less than a peak value of the network voltage.

The inverter assembly of FIG. 1 can be an NPC inverter assembly structurally capable of generating five-level output voltage. In an exemplary embodiment, the inverter assembly may include an inverter capable of generating even higher level output voltage, such as seven-level output voltage.

For example, if the switch element K1 is ignored, FIG. 1 depicts a known single phase NPC inverter assembly. Also, the switch positions showed in the switching table 1 are known in the context of the known NPC inverter assembly.

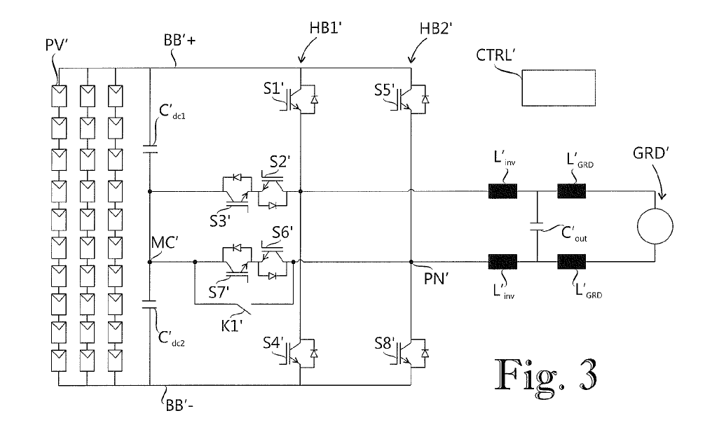

FIG. 3 shows an inverter assembly according to an exemplary embodiment of the disclosure. The inverter assembly of FIG. 3 is herein referred to as an NPC2 inverter assembly.

The NPC2 inverter assembly can include a DC circuit, inverter means, and control means CTRL′ for controlling the inverter means. The DC circuit can include a positive busbar BB′+, a negative busbar BB′−, and input capacitor means. The input capacitor means can include a first energy storage capacitor C′_{dc1} and a second energy storage capacitor C′_{dc2} connected in series between the positive busbar BB′+ and the negative busbar BB′−. There is a midpoint MC′ between the first energy storage capacitor C′_{dc1} and the second energy storage capacitor C′_{dc2}.

The inverter means can be adapted to convert a direct current supplied into the inverter means through the positive busbar BB′+ and the negative busbar BB′− to an alternating current, and to feed the alternating current through output terminals of the inverter means to an electrical network GRD′ having a network voltage. The inverter means can be multilevel inverter means comprising a first half bridge HB1′ and a second half bridge HB2′.

The first half bridge HB1′ can include controllable switches S1′ and S4′ connected in series between the positive busbar BB′+ and the negative busbar BB′−. The first half bridge HB1′ can include a first switch leg comprising controllable switches S2′ and S3′ connected in series such that their forward directions are opposite to each other. A first end of the first switch leg can be connected to a point between controllable switches S1′ and S4′. A second end of the first switch leg can be connected to the midpoint MC′.

The second half bridge HB2′ can include controllable switches S5′ and S8′ connected in series between the positive busbar BB′+ and the negative busbar BB′−. A neutral reference point PN′ can be between the controllable switches S5′ and S8′. Between the neutral reference point PN′ and the midpoint MC′ there can be a second switch leg comprising controllable switches S6′ and S7′ connected in series such that their forward directions are opposite to each other. A switch element K1′ can be between the neutral reference point PN′ and the midpoint MC′. In its on-position the switch element K1′ electrically connects the neutral reference point PN′ and the midpoint MC′. In its off-position the switch element K1′ electrically separates the neutral reference point PN′ and the midpoint MC′

The NPC2 inverter assembly can include two inverter side inductors L′ᵢₙᵥ, two grid side inductors L′_{GRD} and an output capacitor C′ₒᵤₜ, which can be connected in the same way as the inverter side inductors Lᵢₙᵥ, the grid side inductors L_{GRD} and the output capacitor Cₒᵤₜ in the NPC inverter assembly of FIG. 1.

The control means CTRL′ can be adapted to provide a first operating state in which the control means CTRL′ operate the inverter means as a full-bridge inverter. The control means CTRL′ can be adapted to provide a second operating state and a third operating state in which the control means CTRL′ operate the inverter means as a half-bridge inverter.

The switching tables 1, 2 and 3 apply to the NPC2 inverter assembly when switches S1-S8 are renamed as switches S1′-S8′, and the switch element K1 is renamed as switch element K1′. Further, predetermined conditions based on which the control means CTRL′ can be adapted to select an operating state may be the same as explained in connection to the inverter assembly of FIG. 1.

Each of the controllable switches S1-S8 in the inverter assembly of FIG. 1 and each of the controllable switches S1′-S8′ in the inverter assembly of FIG. 3 can include a diode element connected antiparallel with actual switch element. The controllable switches may be for example IGBTs or MOSFETs.

In the exemplary embodiments shown in FIGS. 1 and 3 the first half bridge can include the same number of controllable switches as the second half bridge. In an exemplary embodiment, the first half bridge can include a different number of controllable switches than the second half bridge.

Inverter assemblies of FIGS. 1 and 3 can be suitable for use in a solar power plant because a common mode voltage in the DC circuits thereof is a direct voltage and therefore no common mode current is generated between photovoltaic cells and the ground. For example, this feature can be used in connection with thin film photovoltaic cells.

In addition to an inverter assembly, each of the FIGS. 1 to 3 depicts a plurality of photovoltaic cell units, denoted as PV or PV′, connected to the inverter assembly. Consequently each of the FIGS. 1 to 3 depicts a solar power plant can include a power supply means, the power supply means can include the plurality of photovoltaic cell units and supply terminals, each of the plurality of photovoltaic cell units adapted to convert solar energy into direct current and to feed the direct current out of the power supply means via the supply terminals, the supply terminals of the power supply means connected to the positive busbar and negative busbar of the DC circuit of the inverter assembly.

It will be apparent to a person skilled in the art that the inventive concepts disclosed herein can be implemented in various ways. The invention and its embodiments are not limited to the examples described above but may vary within the scope of the claims.

Thus, it will be appreciated by those skilled in the art that the present invention can be embodied in other specific forms without departing from the spirit or essential characteristics thereof. The presently disclosed exemplary embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An inverter assembly comprising:
a DC circuit, wherein the DC circuit includes a positive busbar, a negative busbar and input capacitor means, the input capacitor means having a midpoint and connected between the positive busbar and the negative busbar;
inverter means, the inverter means being adapted to convert a direct current supplied through the positive busbar and the negative busbar to an alternating current, and configured to feed the alternating current through output terminals of the inverter means to an electrical network having a network voltage, wherein the inverter means is a multilevel inverter means including a first half bridge and a second half bridge, each of the first and second half bridges having controllable switches; and
control means configured to control the inverter means, the control means being adapted to provide a first operating state in which the control means operates the inverter means as a full-bridge inverter, and wherein the control means is adapted to provide at least one further operating state in which the control means operates the inverter means as a half-bridge inverter, wherein one of the half bridges is disconnected from the positive busbar and the negative busbar while a neutral reference point of said one of the half bridges is connected to the midpoint of the input capacitor means, the control means being adapted to select an operating state based on predetermined conditions.

2. An inverter assembly according to claim 1, wherein the at least one further operating state comprises:
a second operating state in which the neutral reference point is connected to the midpoint of the input capacitor means through a subset of the controllable switches of said one of the half bridges.

3. An inverter assembly according to claim 1, comprising:
a switch element between the neutral reference point and the midpoint of the input capacitor means; and
the at least one further operating state includes a third operating state in which the neutral reference point is connected to the midpoint of the input capacitor means through the switch element.

4. An inverter assembly according to claim 3, wherein the switch element is a relay.

5. An inverter assembly according to claim 1, comprising:
an input direct voltage present between the positive busbar and the negative busbar during use.

6. An inverter assembly according to claim 5, wherein the control means are adapted to select the first operating state when the input direct voltage is less than twice an absolute value of instantaneous value of the network voltage.

7. An inverter assembly according to claim 2, comprising:
an input direct voltage present between the positive busbar and the negative busbar during use; and
wherein the control means are adapted to select the second operating state when the input direct voltage is greater than twice an absolute value of instantaneous value of the network voltage.

8. An inverter assembly according to claim 3, comprising:
an input direct voltage present between the positive busbar and the negative busbar during use; and
wherein the control means are adapted to select the third operating state when the input direct voltage is greater than twice a peak value of the network voltage.

9. A solar power plant comprising:
power supply means, the power supply means comprising at least one photovoltaic cell unit and supply terminals, each of the at least one photovoltaic cell unit being adapted to convert solar energy into direct current and to feed the direct current out of the power supply means via the supply terminals;
an inverter assembly, the inverter comprising:
a DC circuit, wherein the DC circuit includes a positive busbar, a negative busbar and input capacitor means, the input capacitor means having a midpoint and connected between the positive busbar and the negative busbar;
inverter means, the inverter means being adapted to convert a direct current supplied through the positive busbar and the negative busbar to an alternating current, and configured to feed the alternating current through output terminals of the inverter means to an electrical network having a network voltage, wherein the inverter means is a multilevel inverter means including a first half bridge and a second half bridge, each of the first and second half bridges having controllable switches; and
control means configured to control the inverter means, the control means being adapted to provide a first operating state in which the control means operates the inverter means as a full-bridge inverter, and wherein the control means is adapted to provide at least one further operating state in which the control means operates the inverter means as a half-bridge inverter, wherein one of the half bridges is disconnected from the positive busbar and the negative busbar while a neutral reference point of said one of the half bridges is connected to the midpoint of the input capacitor means, the control means being adapted to select an operating state based on predetermined conditions; and
wherein the supply terminals of the power supply means are connected to the positive busbar and the negative busbar.

10. A solar power plant according to claim 9, wherein the at least one further operating state comprises:
a second operating state in which the neutral reference point is connected to the midpoint of the input capacitor means through a subset of the controllable switches of said one of the half bridges.

11. A solar power plant according to claim 9, wherein the inverter assembly comprises:
a switch element between the neutral reference point and the midpoint of the input capacitor means; and
the at least one further operating state includes a third operating state in which the neutral reference point is connected to the midpoint of the input capacitor means through the switch element.

12. A solar power plant according to claim 11, wherein the switch element is a relay.

13. A solar power plant according to claim 9, comprising:
an input direct voltage present between the positive busbar and the negative busbar during use.

14. A solar power plant according to claim 13, wherein the control means are adapted to select the first operating state when the input direct voltage is less than twice an absolute value of instantaneous value of the network voltage.

15. A solar power plant according to claim 10, comprising:
an input direct voltage present between the positive busbar and the negative busbar during use; and
wherein the control means are adapted to select the second operating state when the input direct voltage is greater than twice an absolute value of instantaneous value of the network voltage.

16. A solar power plant according to claim 11, comprising:
an input direct voltage present between the positive busbar and the negative busbar during use; and
wherein the control means are adapted to select the third operating state when the input direct voltage is greater than twice a peak value of the network voltage.
